(19) United States
(12) Patent Application Publication
(10) Pub. No.: US 2015/0033180 A1
(43) Pub. Date: Jan. 29, 2015

(54) DISPLAY CONTROL APPARATUS, DISPLAY CONTROL METHOD, DISPLAY CONTROL SIGNAL GENERATING APPARATUS, DISPLAY CONTROL SIGNAL GENERATING METHOD, PROGRAM, AND DISPLAY CONTROL SYSTEM

(71) Applicant: SONY CORPORATION, Tokyo (JP)

(72) Inventors: Yusuke NAKAGAWA, Tokyo (JP); Kunihito SAWAI, Kanagawa (JP); Hiroyuki MIZUNUMA, Tokyo (JP); Yuhei TAKI, Kanagawa (JP); Ikuo YAMANO, Tokyo (JP); Keisuke YAMAOKA, Tokyo (JP)

(21) Appl. No.: 14/335,259

(22) Filed: Jul. 18, 2014

(30) Foreign Application Priority Data
Jul. 26, 2013 (JP) 2013-155447

(51) Int. Cl. G06F 3/0485; G06F 3/0481

(52) U.S. Cl. CPC G06F 3/0485; G06F 3/04812
USPC 715/784

(57) ABSTRACT

There is provided a display control apparatus including a display control unit configured to move a cursor position displayed on a display unit or to scroll a screen displayed on the display unit in accordance with a change amount of an indicated direction of a direction indicator, and a switching control unit configured to switch the display control unit moving the cursor position and the display control unit scrolling the screen. After the switching control unit switches the display control unit scrolling the screen to the display control unit moving the cursor position, the display control unit reduces a movement amount of the cursor position with respect to the change amount.

### CROSS REFERENCE TO RELATED APPLICATIONS

This application claims the benefit of Japanese Priority Patent Application JP 2013-155447 filed Jul. 26, 2013, the entire contents of which are incorporated herein by reference.

### BACKGROUND

The present disclosure relates to a display control apparatus, a display control method, a display control signal generating apparatus, a display control signal generating method, a program, and a display control system.

Operation terminals having a remote controller function are used today to externally operate a variety of information processing apparatuses such as television receivers and personal computers (PCs). As the functions of information processing apparatuses grow diverse, operation terminals more commonly have various operations performed on the screen. One of such operation terminals is equipped with a motion sensor, and performs various processing such as displaying a cursor at the corresponding position, moving focus, and selecting an icon on the basis of the direction of the operation terminal.

Some operation terminals equipped with a motion sensor absolutely detect directions of the operation terminals, and others detect the operations of the operation terminals with an acceleration sensor or a gyro sensor to estimate directions of the operation terminals. The latter operation terminals each may have a gap between the actual direction of the operation terminal and the estimated direction of the operation terminal. Accordingly, a technique for cancelling such gaps has been developed for the latter operation terminals.

JP 2011-238350A discloses, for example, a technique for detecting the movement of an operation terminal with a sensor and further modifying the detected operation to more accurately estimate the actual direction of the operation terminal.

### SUMMARY

Such a technique, however, does not absolutely detect a direction of an operation terminal. Consequently, there may be still a gap between the actual direction of the operation terminal and the estimated direction of the operation terminal. Accordingly, a gap unfortunately occurs between the actual direction of the operation terminal and a cursor position displayed on the screen. JP 2011-238350A, however, does not mention any technique for cancelling gaps that have already occurred.

The present disclosure therefore proposes a novel and improved display control apparatus, display control method, display control signal generating apparatus, display control signal generating method, program, and display control system capable of easily cancelling a gap between the actual direction of an operation terminal and a cursor position.

According to an embodiment of the present disclosure, there is provided a display control apparatus including a display control unit configured to move a cursor position displayed on a display unit or to scroll a screen displayed on the display unit in accordance with a change amount of an indicated direction of a direction indicator, and a switching control unit configured to switch the display control unit moving the cursor position and the display control unit scrolling the screen. After the switching control unit switches the display control unit scrolling the screen to the display control unit moving the cursor position, the display control unit reduces a movement amount of the cursor position with respect to the change amount.

According to another embodiment of the present disclosure, there is provided a display control method including moving a cursor position displayed on a display unit or scrolling a screen displayed on the display unit in accordance with a change amount of an indicated direction of a direction indicator, switching moving the cursor position and scrolling the screen, and reducing a movement amount of the cursor position with respect to the change amount after scrolling the screen is switched to moving the cursor position.

According to still another embodiment of the present disclosure, there is provided a program for causing a computer to execute moving a cursor position displayed on a display unit or scrolling a screen displayed on the display unit in accordance with a change amount of an indicated direction of a direction indicator, switching moving the cursor position and scrolling the screen, and reducing a movement amount of the cursor position with respect to the change amount after scrolling the screen is switched to moving the cursor position.

According to yet another embodiment of the present disclosure, there is provided a display control signal generating apparatus including a detection unit configured to detect a change amount of an indicated direction, a generation unit configured to generate a display control signal that requests a cursor position displayed on a display unit to be moved or a display control signal that requests a screen displayed on the display unit to be scrolled in accordance with the change amount detected by the detection unit, and a switching control unit configured to switch the generation unit generating the display control signal that requests the cursor position to be moved and the generation unit generating the display control signal that requests the screen to be scrolled. After the switching control unit switches the generation unit generating the display control signal that requests the screen to be scrolled to the generation unit generating the display control signal that requests the cursor position to be moved, the generation unit generates a display control signal in which a movement amount of the cursor position with respect to the change amount is reduced.

Further, according to an embodiment of the present disclosure, there is provided a display control signal generating method including detecting a change amount of an indicated direction, generating a display control signal that requests a cursor position displayed on a display unit to be moved or a display control signal that requests a screen displayed on the display unit to be scrolled in accordance with the detected change amount, switching generating the display control signal that requests the cursor position to be moved and generating the display control signal that requests the screen to be scrolled, and generating a display control signal in which a movement amount of the cursor position with respect to the change amount is reduced after generating the display control signal that requests the screen to be scrolled is switched to generating the display control signal that requests the cursor position to be moved.

Still further, according to an embodiment of the present disclosure, there is provided a program for causing a computer to execute detecting a change amount of an indicated direction, generating a display control signal that requests a cursor position displayed on a display unit to be moved or a display control signal that requests a screen displayed on the display unit to be scrolled in accordance with the detected change amount, switching generating the display control signal that requests the cursor position to be moved and generating the display control signal that requests the screen to be scrolled, and generating a display control signal in which a movement amount of the cursor position with respect to the change amount is reduced after generating the display control signal that requests the screen to be scrolled is switched to generating the display control signal that requests the cursor position to be moved.

Yet further, according to an embodiment of the present disclosure, there is provided a display control system including a detection unit configured to detect a change amount of an indicated direction, a display control unit configured to move a cursor position displayed on a display unit or to scroll a screen displayed on the display unit in accordance with the change amount detected by the detection unit, and a switching control unit configured to switch the display control unit moving the cursor position and the display control unit scrolling the screen. After the switching control unit switches the display control unit scrolling the screen to the display control unit moving the cursor position, the display control unit reduces a movement amount of the cursor position with respect to the change amount.

According to one or more of embodiments of the present disclosure, it is possible to easily cancel a gap between the actual direction of an operation terminal and a cursor position.

### BRIEF DESCRIPTION OF THE DRAWINGS

FIG. 1 is an explanatory diagram illustrating an overview of a display control system according to an embodiment of the present disclosure;

FIG. 2 is an explanatory diagram illustrating an example of screen display according to an embodiment of the present disclosure;

FIG. 3 is an explanatory diagram illustrating an overview of display control processing according to an embodiment of the present disclosure;

FIG. 4 is a block diagram illustrating a configuration of a display control system according to a first embodiment;

FIG. 5 is a diagram for describing an example of release processing according to the first embodiment;

FIG. 6 is a sequence diagram illustrating an operation of the display control system according to the first embodiment;

FIG. 7 is a block diagram illustrating a configuration of a display control system according to a second embodiment; and

FIG. 8 is a sequence diagram illustrating an operation of the display control system according to the second embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order.

1. Overview of Display Control Processing according to Embodiment of Present

### 2. Disclosure

### 2. Embodiments

2-1. First Embodiment
   2-1-1. Configuration
   2-1-2. Operational Processing
2-2. Second Embodiment
   2-7-1. Configuration
   2-2-2. Operational Processing

### 3. Conclusion

### 1. OVERVIEW OF DISPLAY CONTROL PROCESSING ACCORDING TO EMBODIMENT OF PRESENT DISCLOSURE

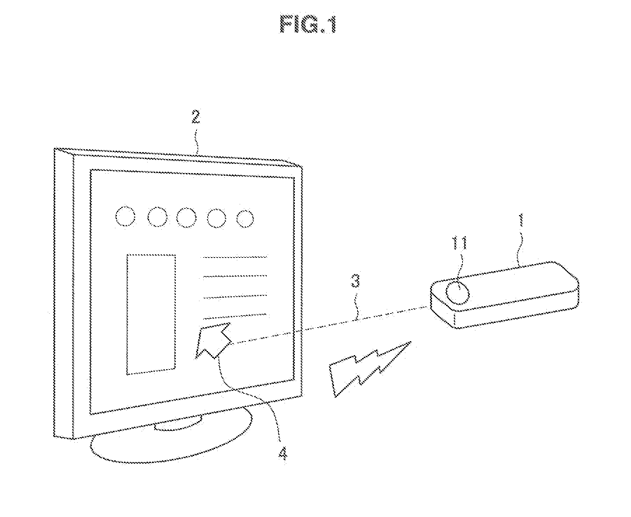

First of all, an overview of display control processing according to an embodiment of the present disclosure will be described with reference to FIGS. 1 to 3.

FIG. 1 is an explanatory diagram illustrating an overview of a display control system according to an embodiment of the present disclosure. As illustrated in FIG. 1, the display control system according to the embodiment of the present disclosure includes an operation terminal 1 and a display apparatus 2, and performs display control processing. The display control system according to the present embodiment does not absolutely detect a direction of the operation terminal 1 to control display, but estimates the direction on the basis of a detection result from a sensor built in the operation terminal 1 to perform display control processing.

The operation terminal 1 is operated by a user, detects the inclination or the movement with an accelerator sensor or a gyro sensor, and transmits the detection result to the display apparatus 2. The display apparatus 2 estimates an indicated direction 3, which is a direction of the operation terminal 1, on the basis of the detection result from the operation terminal 1, and displays a screen based on the estimated indicated direction 3.

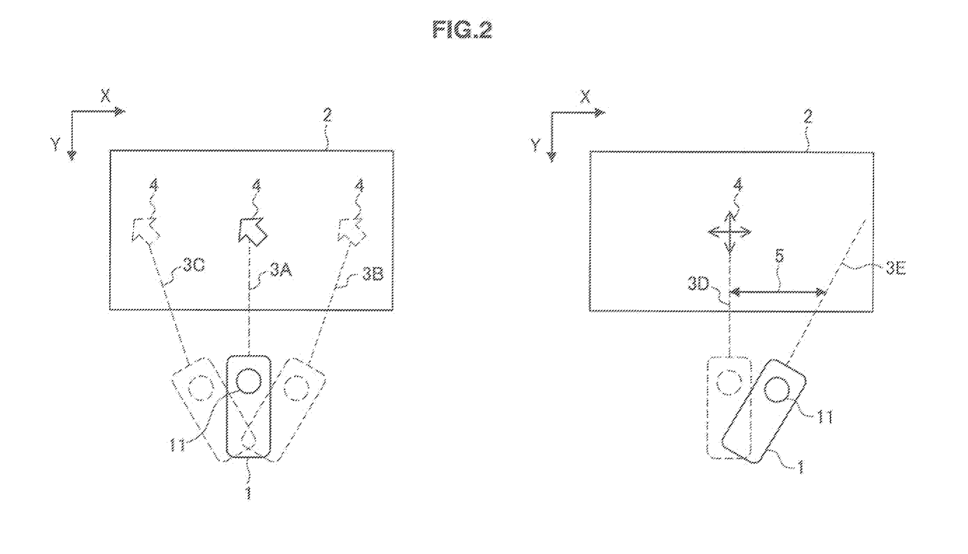

The display control system according to the present embodiment has two operational modes including a cursor movement mode and a scroll mode. The movement of the operation terminal 1 is mapped to the movement of a cursor 4 in the cursor movement mode. Meanwhile, the movement of the operation terminal 1 is mapped to an amount of scrolling in the scroll mode. An operation unit 11 of the operation terminal 1 has a function of switching the cursor movement mode and the scroll mode. Users can switch these operational modes at given timing. The cursor movement, mode will be first described below with reference to FIG. 2.

FIG. 2 is an explanatory diagram illustrating an example of screen display according to an embodiment of the present disclosure. As illustrated in FIG. 2, when the operation terminal 1 points in an indicated direction 3A, the display apparatus 2 displays the cursor 4 at the position corresponding to the indicated direction 3A. A position at which the cursor 4 is displayed will also be called cursor position below.

When a user moves the operation terminal 1 in an X-direction and the operation terminal 1 points in an indicated direction 3B, the display apparatus 2 displays the cursor 4 at the position corresponding to the indicated direction 3B in the cursor movement mode. When a user moves the operation terminal 1 in the opposite direction to the X-direction and the operation terminal 1 points in an indicated direction 3C, the display apparatus 2 displays the cursor 4 at the position corresponding to the indicated direction 3C. The movement in the X-direction has been described here, but the same applies to the movement in a Y-direction. The same also applies to diagonal directions. In this way, a user moves the operation terminal 1 in a given direction in the cursor movement mode to move the cursor 4 displayed on the display apparatus 2 in the corresponding direction.

Meanwhile, a user moves the operation terminal 1 in a given direction in the scroll mode to scroll a screen displayed on the display apparatus 2 in the corresponding direction.

When a screen is scrolled, a position of the cursor 4 is here fixed and is not moved. Accordingly, a gap between the fixed cursor position and the indicated direction 3 of the operation terminal 1 may grow as much as a user moves the operation terminal 1 for scrolling. A gap caused by scrolling will also be called positional gap below. A positional gap occurring when a screen is scrolled will be described below with reference to FIG. 2.

As illustrated in FIG. 2, when a user points the operation terminal 1 in an indicated direction 3D, the operation unit 11 shall switch the operational mode to the scroll mode and the user shall turn the operation terminal 1 in an indicated direction 3D. A screen displayed on the display apparatus 2 is scrolled in the corresponding direction by an amount according to a change from the indicated direction 3D to an indicated direction 3E. As illustrated in FIG. 2, the cursor 4 displayed during scrolling is a cross arrow indicating that the scroll mode operation, which is different from an arrow in the cursor movement mode. A position of the cursor 4 is fixed and is not moved during scrolling. Accordingly, a different 5 (positional gap) as illustrated in FIG. 2 occurs between the cursor position and the indicated position 3E after scrolling.

If a direction of the operation terminal 1 is absolutely detected and display is controlled, such a positional gap does not occur. It is, however, difficult to avoid such a position gap if there is no way for absolutely detecting a direction as described for the operation terminal 1 according to the present embodiment.

Alternately, a cursor position may not be fixed. However, even though a cursor position is not fixed, continuous scrolling after the cursor 4 reaches a screen end also causes a positional gap because the position of the cursor 4 stays at the screen end but a direction of the operation terminal 1 changes. Furthermore, positional gaps repeat occurring during scrolling, which gives a user an uncomfortable impression. In effect, in such a situation, a scroll operation causes a positional gap if a cursor position is not fixed during the scroll operation.

Accordingly, in view of such circumstances, display control processing according to embodiments of the present disclosure has been developed. The display control processing according to each embodiment of the present disclosure can cancel a positional gap caused by a scroll operation.

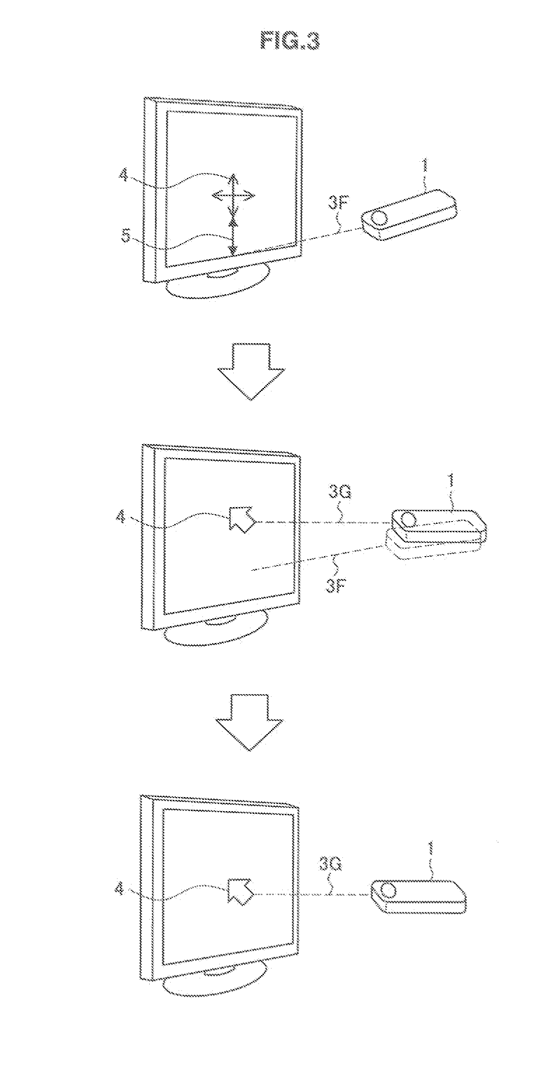

Specifically, the display control system according to the present embodiment reduces a movement amount of the cursor 4 after the scroll operation. This allows the display control system to cancel a positional gap using a user operation. An overview of such display control processing will be described below with reference to FIG. 3.

FIG. 3 is an explanatory diagram illustrating an overview of display control processing according to an embodiment of the present disclosure. As illustrated in FIG. 3, the difference 5 is caused by a scroll operation between a position of the cursor 4 and an indicated direction 3F of the operation terminal 1. Generally, users naturally try to match a direction of the operation terminal 1 with a position of the cursor 4 after finishing scrolling. Accordingly, the display control system according to the present embodiment cancels the difference 5 using a natural operation of a user.

Specifically, the display control system according to the present embodiment does not perform normal cursor movement immediately after switched to the cursor movement mode. As illustrated in FIG. 3, the display apparatus 2 reduces a movement amount of the cursor 4 such as fixing a position of the cursor 4 and decelerating the cursor 4 until a direction of the operation terminal 1 has moved from the indicated direction 3F to the position of the cursor 4. Such processing of reducing a movement amount of the cursor 4 will also be called deceleration processing below.

The display apparatus 2 releases deceleration processing and performs normal cursor movement at timing at which a cursor position is predicted to match with a direction of the operation terminal 1, that is, a direction of the operation terminal 1 matches with an indicated direction 3G as illustrated in FIG. 3. Matching a position of the cursor 4 with a direction of the operation terminal 1 will also be called positioning below. Processing of releasing deceleration processing will also be called release processing.

If normal cursor movement is performed without deceleration processing after the cursor movement mode is set, positioning is not possible because a cursor position moves in accordance with the movement of the indicated direction 3. The display control system according to the present embodiment can lessen the movement of the cursor 4 such as fixing a position of the cursor 4 until timing at which the indicated direction 3 is predicted to match with the position of the cursor 4, allowing a user to naturally perform positioning. The display apparatus 2 performs release processing at timing at which positioning is predicted to be completed so a user can naturally and smoothly perform the following operation.

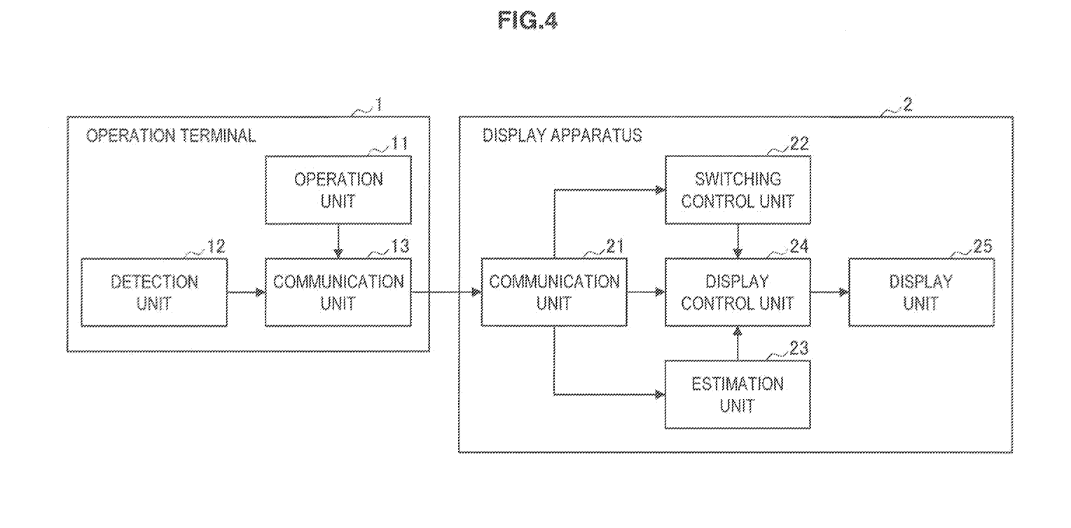

The overview of the display control processing according to the present embodiment has been described above. Next, the details will be described for embodiments with reference to FIGS. 4 to 8.

### 2. EMBODIMENTS

### 2-1. First Embodiment

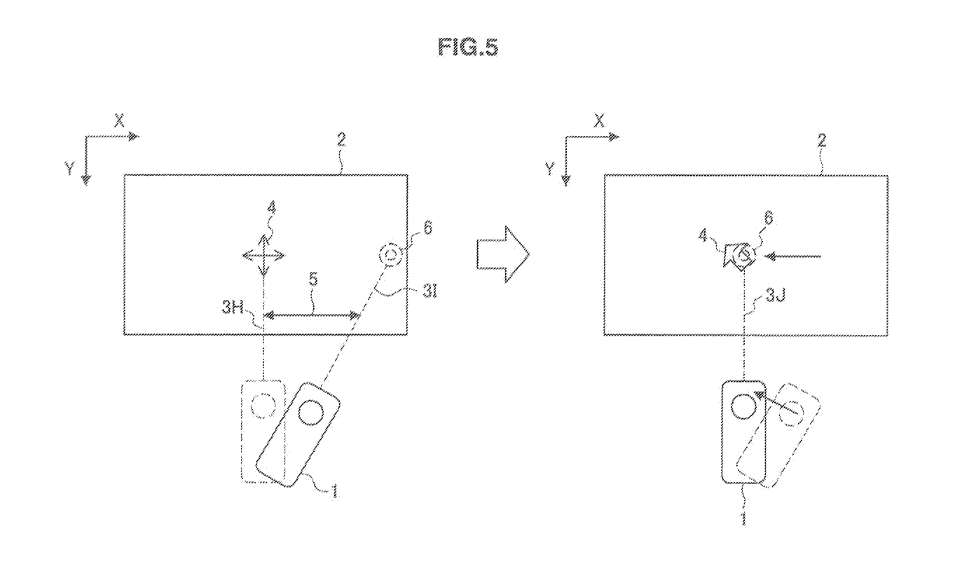

The display apparatus 2 (display control apparatus) primarily performs display control processing in the present embodiment. First of all, a configuration of the display control system according to the present embodiment will be described with reference to FIGS. 4 and 5.

[1-1. Configuration]

FIG. 4 is a block diagram illustrating a configuration of a display control system according to a first embodiment. As illustrated in FIG. 4, the display control system according to the present embodiment includes an operation terminal 1 and a display apparatus 2.

(Operation Terminal 1)

The operation terminal 1 is operated by a user, detects a user operation, and transmits the detection result to the display apparatus 2. The operation terminal 1 is implemented, for example, as a dedicated information processing apparatus, a smartphone, a tablet terminal, a mobile phone terminal, a portable music player, a portable video processing apparatus, or a portable game console. The operation terminal 1 includes an operation unit 11, a detection unit 12, and a communication unit 13.

Operation Unit 11

The operation unit 11 has a function of switching the operational mode of the display control system to a cursor movement mode or a scroll mode. The operation unit 11 is implemented, for example, as a button, a touch panel, or a touch pad. The operation unit 11 shall be herein implemented as a button, and is also called scroll button. The display control system may operate in the scroll mode while the scroll button is being pushed down. Meanwhile, the display control system may operate in the cursor movement mode while the scroll button is not being pushed down.

When a user pushes down the button, the operation unit 11 generates scroll start information that requests an operation in the scroll mode to be started and outputs the generated scroll start information to the communication unit 13. Meanwhile, when a user releases the button, the operation unit 11 generates scroll end information that requests the operation in the scroll mode to be finished and outputs the generated scroll end information to the communication unit 13.

Detection Unit 12

The detection unit 12 has a function of detecting a change amount of the indicated direction 3 of the operation terminal 1. The detection unit 12 is implemented, for example, as an acceleration sensor or a gyro sensor. The detection unit 12 outputs change amount information indicating the detected change amount to the communication unit 13.

Communication Unit 13

The communication unit 13 is a communication module that transmits data to and receives data from an external apparatus. The communication unit 13 performs wireless communication directly or via a network access point with an external apparatus in a scheme such as a wireless local area network (LAN), Wireless Fidelity (Wi-Fi) (registered trademark), infrared communication, and Bluetooth (registered trademark). The communication unit 13 according to the present embodiment transmits the scroll start information or the scroll end information output from the operation unit 11 to the display apparatus 2. Additionally, the communication unit 13 transmits the change amount information output from the detection unit 12 to the display apparatus 2.

(Display Apparatus 2)

The display apparatus 2 displays an image on the basis of the information received from the operation terminal 1. The display apparatus 2 is implemented, for example, as a television receiver, a display, a notebook PC, a smartphone, a tablet terminal, a mobile phone terminal, a portable video processing apparatus, or a portable game console. The display apparatus 2 includes a communication unit 21, a switching control unit 22, an estimation unit 23, a display control unit 24, and a display unit 25.

Communication Unit 21

The communication unit 21 is a communication module that transmits data to and receives data from an external apparatus. The communication unit 21 performs wireless communication directly or via a network access point with an external apparatus in a scheme such as a wireless LAN, Wi-Fi (registered trademark), infrared communication, and Bluetooth (registered trademark). The communication unit 21 according to the present embodiment functions as a reception unit that receives information indicating a change amount of the indicated direction 3 from the operation terminal 1, and receives change amount information, scroll start information, and scroll end information from the operation terminal 1. The communication unit 21 outputs the received information to the switching control unit 22, the estimation unit 23, and the display control unit 24.

Switching Control Unit 22

The switching control unit 22 has a function of switching the cursor movement mode and the scroll mode. More specifically, the switching control unit 22 switches an operational mode of the display control unit 24, which will be described below, to the cursor movement mode or the scroll mode on the basis of the information received from the operation terminal 1.

A specific switching operation will be described. First of all, the switching control unit 22 controls the display control unit 24 such that the display control unit operates in the cursor movement mode as an initial operational mode. When the communication unit 21 receives scroll start information from the operation terminal 1, the switching control unit 22 switches the operational mode such that the display control unit 24 operates in the scroll mode. When the communication unit 21 receives scroll end information from the operation terminal 1, the switching control unit 22 switches the operational mode such that the display control unit 24 operates in the cursor movement mode.

In addition, if the cursor 4 reaches a screen end of the display unit 25 while the display control unit 24 is operating in the cursor movement mode, the switching control unit 22 may switch the cursor movement mode to the scroll mode on the basis of the change amount information received by the communication unit 21 from the operation terminal 1. The switching control unit 22 may switch the scroll mode to the cursor movement mode at timing at which the cursor 4 leaves the screen end of the display unit 25.

Estimation Unit 23

The estimation unit 23 has a function of estimating the indicated direction 3 of the operation terminal 1 in accordance with a change amount of the indicated direction 3 of the operation terminal 1. As discussed above, a cursor position is fixed in a scroll operation, and a cursor position is fixed or the cursor is decelerated in deceleration processing. While a cursor position is fixed or the cursor is decelerated in this way, the estimation unit 23 keeps estimating the indicated direction 3. On the basis of the estimated indicated direction 3, the estimation unit 23 further estimates a virtual cursor position that is presumptively assumed not to be fixed or decelerated. The estimation unit 23 outputs information indicating the estimated cursor position to the display control unit 24.

Display Control Unit 24

The display control unit 24 has a function of moving a cursor position displayed on the display unit 25 or scrolling a screen displayed on the display unit 25 in accordance with a change amount of the indicated direction 3 of the operation terminal 1. A large change amount of the indicated direction 3 makes the display control unit 24 move a cursor position much in the corresponding direction in the cursor movement mode, while a small change amount makes the display control unit 24 move a cursor position a little in the corresponding direction. Meanwhile, a large change amount of the indicated direction 3 makes the display control unit 24 fix a cursor position and scroll a screen much in the scroll mode, while a small change amount of the indicated direction 3 makes the display control unit 24 fix a cursor position and scroll a screen a little.

The display control unit 24 further has a function of reducing a movement amount of the cursor 4 with respect to the change amount of the indicated direction 3 shown by the change amount information after the switching control unit 22 switches the scroll mode to the cursor movement mode. Specifically the display control unit 24 performs deceleration processing such as fixing a cursor position and decelerating the cursor after the scroll mode is switched to the cursor movement mode, even though the indicated direction 3 is changed much. As discussed above, the display control unit 24 performs deceleration processing after the scroll mode is switched to the cursor movement mode, thereby allowing a user to perform positioning.

The display control unit 24 also has a function of reducing a movement amount of the cursor 4, and then releasing the reduction. Specifically, the display control unit 24 performs release processing of releasing deceleration processing at timing at which a user is predicted to complete positioning, on the basis of the change amount information received by the communication unit 21 from the operation terminal 1. Various timing for release processing is possible. As an example, four types of timing for release processing will be described below.

First, the display control unit 24 performs release processing at timing according to a changing speed or a changing time of the indicated direction 3 of the operation terminal 1 in the scroll mode before the switching control unit 22 switches the scroll mode to the cursor movement mode. The faster changing speed of the indicated direction 3 in the scroll mode may cause a larger positional gap than the slower changing speed does. Similarly, the longer changing time of the indicated direction 3 in the scroll mode may cause a larger positional gap than the shorter changing time does. A larger positional gap would take a user more time to perform positioning. Accordingly as the changing speed grows faster and the changing time grows longer in the scroll mode, the display control unit 24 spends a longer time before the display control unit 24 performs release processing on the basis of the change amount information.

Second, the display control unit 24 performs release processing at timing according to the changing speed of the indicated direction 3 of the operation terminal 1 after the switching control unit 22 switches the scroll mode to the cursor movement mode. It would presumably take a user a shorter time to perform positioning because the faster changing speed of the indicated direction 3 after the scroll mode is switched to the cursor movement mode may cancel a positional gap faster than the slower changing speed does. Accordingly, the faster changing speed of the indicated direction 3 after the scroll mode is switched to the cursor movement mode makes the display control unit 24 perform release processing within a shorter time on the basis of the change amount information. A user would quickly move the operation terminal 1 in performing positioning if the indicated direction 3 is far away from a cursor position, but the user would be more careful and move the operation terminal 1 more slowly as the indicated direction 3 approaches the cursor position. Accordingly, the display control unit 24 may perform, on the basis of the change amount information, release processing at timing at which the changing speed of the indicated direction 3 after the scroll mode is switched to the cursor movement mode falls below a threshold.

Third, the display control unit 24 performs release processing on the basis of a changing direction of the indicated direction 3 after the switching control unit 22 switches the scroll mode to the cursor movement mode. Specifically, the display control unit 24 performs release processing at timing at which the changing direction of the indicated direction 3 is changed. A user moves the operation terminal 1 in a direction of the cursor 4 for positioning. When a user predicts positioning to be completed, the user operates the operation terminal 1 at will in order to move the cursor 4. Consequently, a changing direction of the indicated direction 3 during positioning would be different from a changing direction while a user is operating the operation terminal 1 at will. Accordingly, the display control unit 24 regards release timing as time when a changing direction of the indicated direction 3 is changed, thereby allowing release processing to be performed at timing at which a user predicts positioning to be completed.

In addition, the display control unit 24 may perform release processing at timing at which a changing direction of the indicated direction 3 differs from the opposite direction to a changing direction during scrolling. As illustrated in FIG. 2, a positional gap (difference 5) caused by scrolling generally occurs in the opposite direction to a changing direction during scrolling. A user moves the operation terminal 1 in the opposite direction to the changing direction during scrolling in order to perform positioning. When the user predicts positioning to be completed, the user then operates the operation terminal 1 at will to move the cursor 4. Accordingly, the display control unit 24 regards release timing as time when a changing direction of the indicated direction 3 differs from the opposite direction to a changing direction during scrolling, thereby allowing release processing to be performed at timing at which a user predict positioning to be completed.

If there has been a gap between a cursor position and the indicated direction 3 before scrolling, it is possible that a positional gap caused by scrolling offsets the original gap and the indicated direction 3 has already matched with the cursor position before the scroll mode is switched to the cursor movement mode. In this case, a user would move the operation terminal 1 at will from the beginning since the user does not perform positioning again, so that a changing direction of the indicated direction 3 is very likely to be different from the opposite direction to a changing direction during scrolling. Accordingly, the display control unit 24 regards release timing as time when a changing direction of the indicated direction 3 differs from the opposite direction to a changing direction during scrolling, thereby allowing release processing to be performed immediately after the scroll mode is switched to the cursor movement mode, if the original gap is offset as discussed above.

Fourth, the display control unit 24 performs release processing if the indicated direction 3 estimated by the estimation unit 23 overlaps with a cursor position. More specifically, the estimation unit 23 keeps estimating the indicated direction 3 of the operation terminal 1 during scrolling and deceleration processing after the scroll mode is switched to the cursor movement mode. The display control unit 24 performs release processing at timing at which the estimated indicated direction 3 overlaps with a cursor position. The specific processing will be described below with reference to FIG. 5.

FIG. 5 is a diagram for describing an example of the release processing according to the first embodiment. As illustrated in FIG. 5, let us assume that when a user points the operation terminal 1 in an indicated direction 3H, the user switches the operational mode to the scroll mode with the operation unit 11 and turns the operation terminal 1 in an indicated direction 3I. In this case, a screen displayed on the display apparatus 2 is scrolled in the corresponding direction by an amount according to a change from the indicated direction 3H to 3I. A positional gap (difference 5) occurs between a position of the cursor 4 and a direction of the operation terminal 1 during scrolling because the cursor position is fixed and is not moved.

The estimation unit 23 keeps estimating a direction of the operation terminal 1 during the scrolling operation to estimate that the operation terminal 1 points in the indicated direction 3I illustrated in FIG. 5, and estimates a virtual cursor position 6 at which the cursor 4 would be displayed if the cursor movement mode was set. The estimation unit 23 further keeps estimating a direction of the operation terminal 1 and the virtual cursor position 6 even while a user is performing positioning after the cursor movement mode is switched to the scroll mode. As illustrated in FIG. 5, positioning by a user points the operation terminal 1 in an indicated direction 3J, and the display control unit 24 performs release processing at timing at which a position of the cursor 4 overlaps with the virtual cursor position 6.

The four types of timing for release processing have been described above. The display control system according to the present embodiment uses the above-described four types of timing for release processing, allowing release processing to be performed at timing at which positioning is predicted to be completed. Consequently, a user can naturally and smoothly perform positioning and the following operation. Additionally, the display control system according to the present embodiment may also combine the four types of release processing.

Display Unit 25

The display unit 25 has a function of displaying (playing back) data of an image (data of a still image/data of a moving image) on the basis of control of the display control unit 24. The display unit 25 is implemented, for example, as a liquid crystal display (LCD) or an organic light-emitting diode (OLED). The display unit 25 according to the present embodiment displays and moves the cursor 4 in the cursor movement mode on the basis of control of the display control unit 24, while the display control unit 25 fixes the cursor 4 and scrolls a screen in the scroll mode.

Supplementary Explanation

The communication unit 21, the switching control unit 22, the estimation unit 23, and the display control unit 24 may be formed as a display control apparatus separated from the display unit 25. The display control apparatus formed of the communication unit 21, the switching control unit 22, the estimation unit 23, and the display control unit 24 may control the display unit 25, which is separately formed, on the basis of the information received from the operation terminal 1 such that an image is displayed.

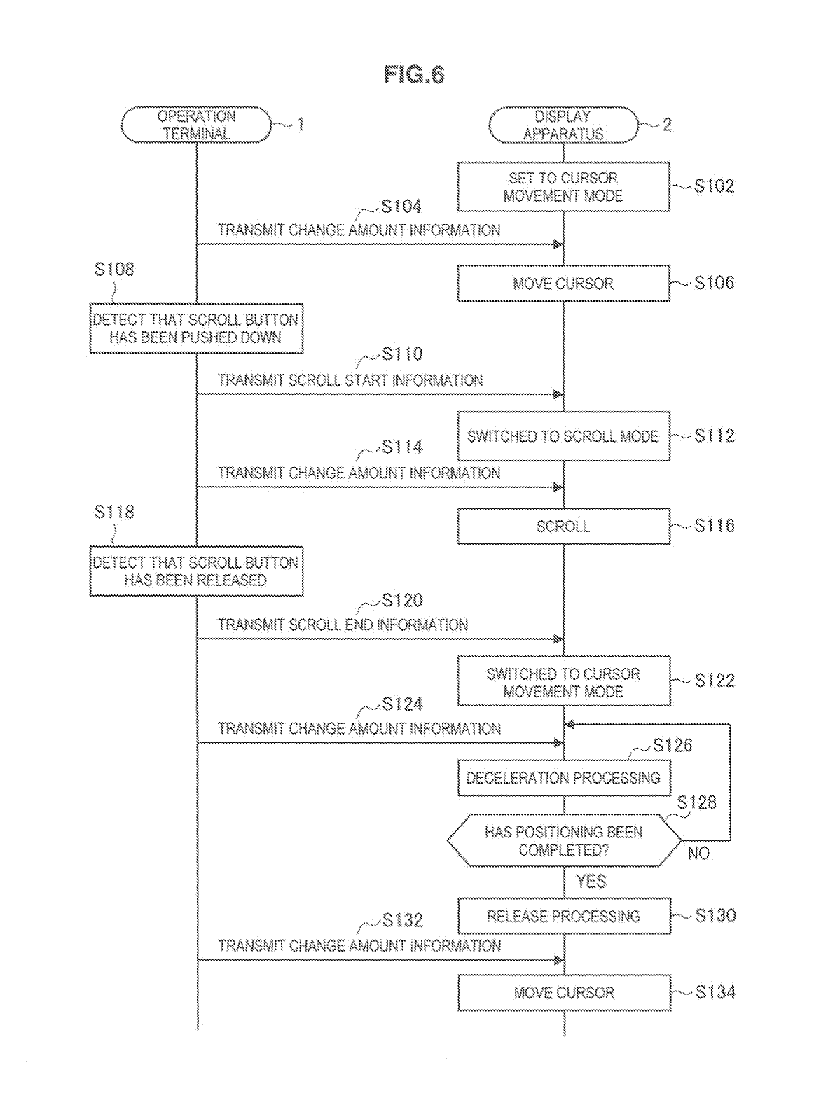

The configuration of the display control system according to the present embodiment has been described above. Next, operational processing of the display control system according to the present embodiment will be described with reference to FIG. 6.

[2-1-2. Operational Processing]

FIG. 6 is a sequence diagram illustrating an operation of the display control system according to the first embodiment. As illustrated in FIG. 6, the switching control unit 22 first sets the operational mode of the display control unit 24 to the cursor movement mode in step S102.

Next, in step S104, the operation terminal 1 transmits, to the display apparatus 2, change amount information indicating a change amount of the indicated direction 3 of the operation terminal 1. More specifically, the detection unit 12 first detects the movement of the operation terminal 1 by a user operation with an acceleration sensor or a gyro sensor, and then generates change amount information indicating a change amount of the indicated direction 3. The communication unit 13 transmits the change amount information generated by the detection unit 12 to the display apparatus 2.

Next, in step S106, the display apparatus 2 moves the cursor 4 on the basis of the information received from the operation terminal 1. More specifically, the display control unit 24 moves the cursor 4 displayed on the display unit 25 in accordance with the change amount information received by the communication unit 21 from the operation terminal 1.

In step S108, the operation terminal 1 then detects that a scroll button has been pushed down. More specifically, the operation unit 11 detects that a user has pushed down the button, generates scroll start information, and outputs the generated scroll start information to the communication unit 13.

Next, in step S110, the operation unit 1 transmits the scroll start information to the display apparatus 2. More specifically, the communication unit 13 transmits the scroll start information generated by the operation unit 11 to the display apparatus 2.

In step S112, the display apparatus 2 then switches the operational mode to the scroll mode. More specifically, the switching control unit 22 switches the operational mode on the basis of the scroll start information received by the communication unit 21 from the operation terminal 1 such that the display control unit 24 operates in the scroll mode.

Next, in step S114, the operation terminal 1 detects the movement of the operation terminal 1 by a user operation, and transmits, to the display apparatus 2, change amount information indicating a change amount of the indicated direction 3.

In step S116, the display apparatus 2 then scrolls a screen. More specifically, the display control unit 24 scrolls a screen displayed on the display unit 25 in accordance with the change amount information received by the communication unit 21 from the operation terminal 1.

Next, in step S118, the operation terminal 1 detects that the scroll button has been released. More specifically, the operation unit 11 detects that a user has released the button, generates scroll end information, and outputs the generated scroll end information to the communication unit 13.

In step S120, the operation terminal 1 then transmits the scroll end information to the display apparatus 2. More specifically, the communication unit 13 transmits the scroll end information generated by the operation unit 11 to the display apparatus 2.

Next, in step S122, the display apparatus 2 switches the operational mode to the cursor movement mode. More specifically, the switching control unit 22 switches the operational mode on the basis of the scroll end information received by the communication unit 21 from the operation terminal 1 such that the display control unit 24 operates in the cursor movement mode.

In step S124, the operation terminal 1 then detects the movement of the operation terminal 1 by a user operation, and transmits, to the display apparatus 2, change amount information indicating a change amount of the indicated direction 3.

In step S126, the display apparatus 2 then performs deceleration processing. More specifically, the display control unit 24 reduces a movement amount of the cursor 4 with respect to the change amount of the indicated direction 3 shown by the change amount information received by the communication unit 21 from the operation terminal 1. Even though the indicated direction 3 is being changed, the display control unit 24, for example, fixes a cursor position or moves the cursor less than the change amount.

In step S128, the display apparatus 2 then determines whether a user has completed positioning. More specifically, the display control unit 24 determines timing at which a user has completed positioning, on the basis of the change amount information received by the communication unit 21 from the operation terminal 1. As discussed above, various timing at which a user is predicted to complete positioning is possible.

First, for example, the display control unit 24 may determine whether a standby time according to a changing speed and a changing time of the indicated direction 3 of the operation terminal 1 in the scroll mode before the switching control unit 22, switches the scroll mode to the cursor movement mode has passed. In this case, if the standby time has not passed, the display control unit 24 determines that positioning is being performed. If the standby time has passed, the display control unit 24 determines that positioning has been completed.

Second, the display control unit 24 may also determine whether a standby time according to a changing speed of the indicated direction 3 of the operation terminal 1 after the switching control unit 22 switches the scroll mode to the cursor movement mode has passed. In this case, if the standby time has not passed, the display control unit 24 determines that positioning is being performed. If the standby time has passed, the display control unit 24 determines that positioning has been completed.

Third, the display control unit 24 may also determine whether a changing direction of the indicated direction 3 after the switching control unit 22 switches the scroll mode to the cursor movement mode has been changed. In this case, if the changing direction of the indicated direction 3 stays constant, the display control unit 24 determines that positioning is being performed. If the changing direction of the indicated direction 3 has been changed, the display control unit 24 determines that positioning has been completed.

Fourth, the display control unit 24 may also determine whether the indicated direction estimated by the estimation unit 23 has overlapped with a cursor position. In this case, if the indicated direction 3 estimated by the estimation unit 23 has not overlapped with a cursor position, the display control unit 24 determines that positioning is being performed. If the indicated direction 3 estimated by the estimation unit 23 has overlapped with a cursor position, the display control unit 24 determines that positioning has been completed.

If it is determined that positioning is being performed (S128/NO), processing returns to step S124 again. That is, the display apparatus 2 fixes or decelerates the cursor 4 until positioning has been completed.

If it is determined that positioning has been completed (S128/YES), the display apparatus 2 performs release processing in step S130. More specifically, the display control unit 24 releases deceleration processing.

Next, in step S132, the operation terminal 1 detects the movement of the operation terminal 1 by a user operation, and transmits, to the display apparatus 2, change amount information indicating a change amount of the indicated direction 3.

In step S134, the display apparatus 2 then moves the cursor 4 on the basis of the information received from the operation terminal 1. More specifically, the display control unit 24 moves the cursor 4 displayed on the display unit 25 by an amount according to the change amount information received by the communication unit 21 from the operation terminal 1 without decelerating the cursor 4.

The operational processing of the display control system according to the present embodiment has been described above.

### 2-2. Second Embodiment

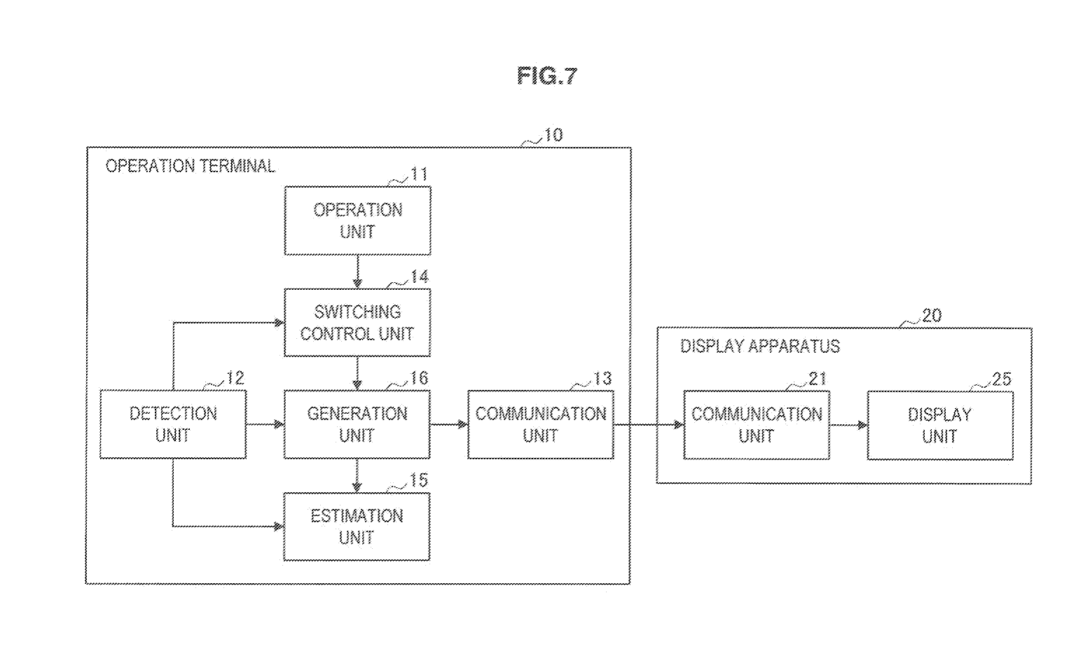

In the present embodiment, an operation terminal 10 (display control signal generating apparatus) primarily performs display control processing. First of all, a configuration of a display control system according to the present embodiment will be described with reference to FIG. 7.

[2-2-1. Configuration]

FIG. 7 is a block diagram illustrating a configuration of a display control system according to a second embodiment. As illustrated in FIG. 7, the display control system according to the present embodiment includes an operation terminal 10 and a display apparatus 20.

(Operation Terminal 10)

The operation terminal 10 is operated by a user, generates a display control signal on the basis of a detection result of a user operation, and transmits the generated display control signal to the display apparatus 20. The operation terminal 10 includes an operation unit 11, a detection unit 12, a communication unit 13, a switching control unit 14, an estimation unit 15, and a generation unit 16.

Operation Unit 11

The operation unit 11 according to the present embodiment has the function as described in the first embodiment, generates scroll start information or scroll end information, and outputs the generated scroll start information or the generated scroll end information to the switching control unit 14.

Detection Unit 12

The detection unit 12 according to the present embodiment has the function as described in the first embodiment, and outputs change amount information to the switching control unit 14, the estimation unit 15, and the generation unit 16.

Switching Control Unit 14

The switching control unit 14 according to the present embodiment has a function of switching a cursor movement mode and a scroll mode like the switching control unit 22 described in the first embodiment. More specifically, the switching control unit 14 switches an operational mode of the generation unit 16, which will be described below, to the cursor movement mode or the scroll mode on the basis of the information output by the operation unit 11 or the detection unit 12.

A specific switching operation will be described. First of all, the switching control unit 14 controls the generation unit 16 such that the generation unit 16 operates in the cursor movement mode as an initial operational mode. If the operation unit 11 outputs scroll start information, the switching control unit 14 switches the operational mode such that the generation unit 16 operates in the scroll mode. To the contrary, if the operation unit 11 outputs scroll end information, the switching control unit 14 switches the operational mode such that the generation unit 16 operates in the cursor movement mode.

In addition, the switching control unit 14 may switch the cursor movement mode to the scroll mode on the basis of the change amount information output by the operation unit 11, if the cursor 4 reaches a screen end of the display unit 25 in the cursor movement mode. The switching control unit 14 may then switch the scroll mode to the cursor movement mode at timing at which the cursor 1 leaves the screen end of the display unit 25.

Estimation Unit 15

The estimation unit 15 according to the present embodiment has the same function as the estimation unit 23 described in the first embodiment, and outputs information indicating the estimated cursor position to the generation unit 16.

Generation Unit 16

The generation unit 16 according to the present embodiment has the same function as the display control unit 21 described in the first embodiment. More specifically, the generation unit 16 has a function of generating a display control signal requesting the cursor 4 displayed on the display unit 25 to be moved or a screen displayed on the display unit 25 to be scrolled in accordance with the change amount information output by the detection unit 12. In the cursor movement mode, the generation unit 16 generates a display control signal requesting a cursor position to be moved much when a change amount of the indicated direction 3 is large. To the contrary, in the cursor movement mode, the generation unit 16 generates a display control signal requesting a cursor position to be moved a little when a change amount of the indicated direction 3 is small. A display control signal generated by the generation unit 16 in the cursor movement mode will also be called cursor movement requesting signal below. In the scroll mode, the generation unit 16 generates a display control signal requesting a cursor position to be fixed and a screen to be scrolled much when a change amount of the indicated direction 3 is large. To the contrary, in the scroll mode, the generation unit 16 generates a display control signal requesting a cursor position to be fixed and a screen to be scrolled a little when a change amount of the indicated direction 3 is small. A display control signal generated by the generation unit 16 in the scroll mode will also be called scroll requesting signal below.

The generation unit 16 further has a function of generating a cursor movement requesting signal after the switching control unit 14 switches the scroll mode to the cursor movement mode, the cursor movement requesting signal reducing a movement amount of the cursor 4 with respect to the change amount of the indicated direction 3 shown by the change amount information. The generation unit 16, for example, generates a cursor movement requesting signal that fixes a cursor position or decelerates the cursor after the scroll mode is switched to the cursor movement mode, even though the indicated direction 3 is changed much. In the present embodiment, such a cursor movement requesting signal that fixes a cursor position or decelerates the cursor is also called cursor decelerated movement requesting signal while generating a cursor decelerated movement requesting signal is also called deceleration processing. As in the first embodiment, the generation unit 16 performs deceleration processing after the scroll mode is switched to the cursor movement mode, thereby allowing a user to perform positioning.

The generation unit 16 also has a function of reducing a movement amount of the cursor 4, and then releasing the reduction. Specifically, the generation unit 16 performs release processing of releasing deceleration processing at timing at which a user is predicted to complete positioning, on the basis of the change amount information output by the detection unit 12. After this release processing, the generation unit 16 generates a normal cursor movement requesting signal. Various timing for release processing is possible. The same four types of timing for release processing as described in the first embodiment are conceivable in the present embodiment as an example, but the detailed description will be here omitted.

The generation unit 16 outputs the generated cursor movement requesting signal, scroll requesting signal, or cursor decelerated movement requesting signal to the communication unit 13.

Communication Unit 13

The communication unit 13 according to the present embodiment has the function as described in the first embodiment, and transmits, to the display apparatus 20, the cursor movement requesting signal, the scroll requesting signal, or the cursor decelerated movement requesting signal output by the generation unit 16.

(Display Apparatus 20)

The display apparatus 20 displays an image on the basis of the information received from the operation terminal 10. The display apparatus 20 includes a communication unit 21 and a display unit 25.

Communication Unit 21

The communication unit 21 according to the present embodiment has the function as described in the first embodiment, and outputs the cursor movement requesting signal, the scroll requesting signal, or the cursor decelerated movement requesting signal received from the operation unit 10 to the display unit 25.

Display Unit 25

The display unit 25 according to the present embodiment has the function as described in the first embodiment, and displays a screen on the basis of the cursor movement requesting signal, the scroll requesting signal, or the cursor decelerated movement requesting signal output from the communication unit 21.

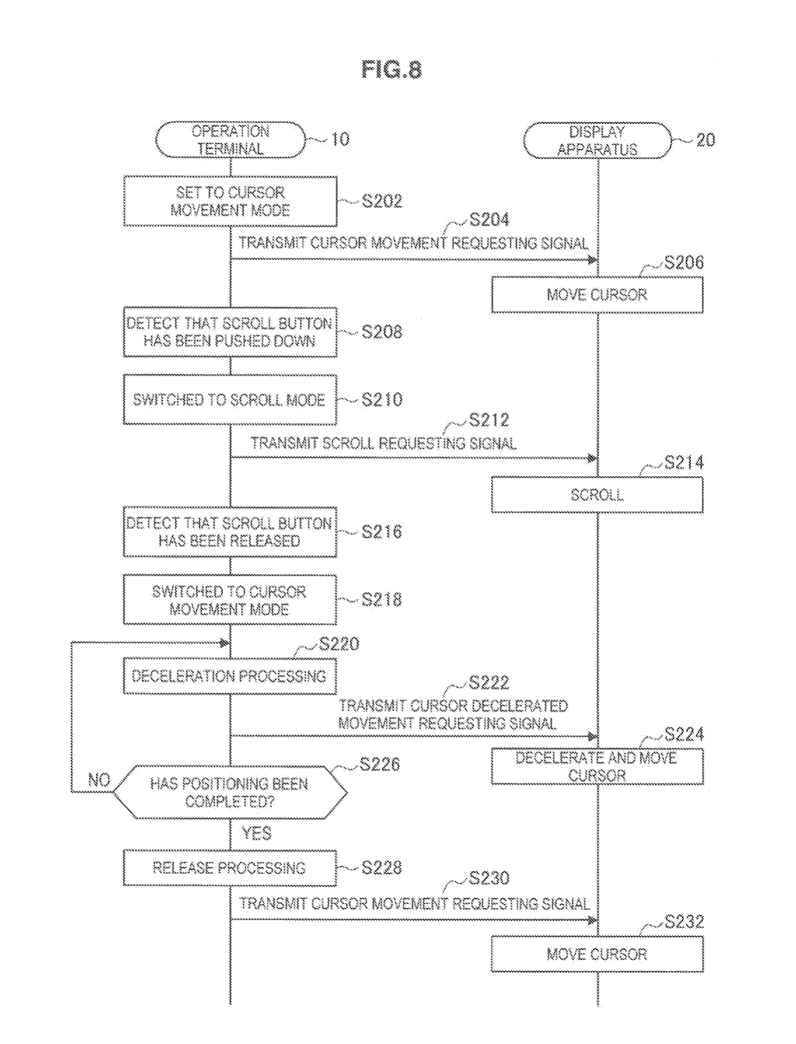

The configuration of the display control system according to the present embodiment has been described above. Next, operational processing of the display control system according to the present embodiment will be described with reference to FIG. 8.

[2-2-2. Operational Processing]

FIG. 8 is a sequence diagram illustrating an operation of the display control system according to the second embodiment. As illustrated in FIG. 8, in step S202, the switching control unit 14 first sets the operational mode of the generation unit 16 to the cursor movement mode.

In step S204, the operation terminal 10 then transmits a cursor movement requesting signal to the display apparatus 20. More specifically, the detection unit 12 first detects the movement of the operation terminal 10 by a user operation with an acceleration sensor or a gyro sensor, and generates change amount information indicating a change amount of the indicated direction 3. Next, the generation unit 16 generates a cursor movement requesting signal requesting the cursor 4 to be moved by an amount according to the change amount of the indicated direction 3 on the basis of the change amount information generated by the detection unit 12. The communication unit 13 then transmits the cursor movement requesting signal generated by the generation unit 16 to the display apparatus 20.

Next, in step S206, the display apparatus 20 moves the cursor 4 on the basis of the information received from the operation terminal 10. More specifically, the display unit 25 moves the cursor 4 on the basis of the cursor movement requesting signal received by the communication unit 21 from the operation terminal 10.

In step S208, the operation terminal 10 then detects that a scroll button has been pushed down. More specifically, the operation unit 11 detects that a user has pushed down the button, generates scroll start information, and outputs the generated scroll start information to the switching control unit 14.

Next, in step S210, the switching control unit 14 switches the operational mode of the generation unit 16 to the scroll mode. More specifically, the switching control unit 14 switches the operational mode of the generation unit 16 to the scroll mode on the basis of the scroll start information output by the operation unit 11.

In step S212, the operation terminal 10 then transmits a scroll requesting signal to the display apparatus 20. More specifically, the generation unit 16 first generates a scroll requesting signal requesting a screen to be scrolled by an amount according to the change amount of the indicated direction 3 on the basis of the change amount information output by the detection unit 12. The communication unit 13 transmits the scroll requesting signal generated by the generation unit 16 to the display apparatus 20.

Next, in step S214, the display apparatus 20 scrolls a screen. More specifically, the display unit 25 scrolls the displayed screen on the basis of the scroll requesting signal received by the communication unit 21 from the operation unit 10.

In step S216, the operation terminal 10 then detects that the scroll button has been released. More specifically, the operation unit 11 detects that a user has released the button, generates scroll end information, and outputs the generated scroll end information to the switching control unit 14.

Next, in step S218, the switching control unit 14 switches the operational mode of the generation unit 16 to the cursor movement mode. More specifically, the switching control unit 14 switches the operational mode of the generation unit 16 to the cursor movement mode on the basis of the scroll end information output by the operation unit 11.

In step S220, the operation terminal 10 then performs deceleration processing. More specifically, the generation unit 16 generates a cursor decelerated movement requesting signal in Which a movement amount of the cursor 4 with respect to the change amount of the indicated direction 3, shown by the change amount information output by the detection unit 12, is reduced. The generation unit 16, for example, generates a cursor decelerated movement requesting signal requesting a cursor position to be fixed or the cursor to be moved less than the change amount, even though the indicated direction 3 is being changed.

In step S222, the operation terminal 10 then transmits the cursor decelerated movement requesting signal to the display apparatus 20. More specifically, the communication unit 13 transmits the cursor decelerated movement requesting signal generated by the generation unit 16 to the display apparatus 20.

In step S224, the display apparatus 20 decelerates and moves the cursor 4. More specifically, the display unit 25 moves the cursor 4 on the basis of the cursor decelerated movement requesting signal received by the communication unit 21 from the operation terminal 10.

Next, in step S226, the display apparatus 20 determines whether a user has completed positioning. More specifically, the generation unit 16 determines timing at which a user has completed positioning, on the basis of the change amount information output by the detection unit 12. Since a determination method has been already described in the first embodiment, the detailed description will be here omitted.

If it is determined that positioning is being performed (S226/NO), processing returns to step S220) again. That is, the operation terminal 10 fixes or decelerates the cursor 4 displayed on the display apparatus 20 until positioning has been completed.

If it is determined that positioning has been completed (S226/YES), the operation terminal 10 performs release processing in step S228. More specifically, the generation unit 16 releases deceleration processing.

In step S230, the operation terminal 10 then transmits a cursor movement requesting signal to the display apparatus 20. More specifically, the generation unit 16 first generates a cursor movement requesting signal requesting the cursor 4 to be moved by an amount according to the change amount of the indicated direction 3 without decelerating the cursor 4, on the basis of the change amount information generated by the detection unit 12. The communication unit 13 transmits the cursor movement requesting signal generated by the generation unit 16 to the display apparatus 20.

In step S232, the display apparatus 20 then moves the cursor 4 on the basis of the cursor movement requesting signal received from the operation terminal 10.

The operational processing of the display control system according to the present embodiment has been described above.

### 3. CONCLUSION

As described above, a display control system according to an embodiment of the present disclosure can easily cancel a positional gap between the actual indicated direction 3 of the operation terminal 1 and a cursor position. More specifically, the display control system performs deceleration processing after the scroll mode is switched to the cursor movement mode, so that the display control system can cancel a positional gap caused by a scroll operation using a natural operation of a user who tries to perform positioning. The display control system performs release processing of releasing deceleration processing at timing at which a user is predicted to complete positioning, thereby accurately cancelling a positional gap. Accordingly, a user can naturally and smoothly perform positioning and the following operation.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

For example, the above-described embodiments have described examples where one of the operation terminal and the display apparatus has all the functions of the switching control unit, the estimation unit, and the display control unit or the generation unit included in the display control system. The present disclosure, however, is not limited thereto. One of the operation terminal and the display apparatus may, for example, separately have those functions. The display control system may also include other information processing apparatuses than the operation terminal and the display apparatus, and the other information processing apparatuses may have those functions and perform display control processing through communication with the operation terminal and the display apparatus.

Although cursor movement has been discussed in the above-described embodiments, the present technology is not limited thereto. The present technology can also be used for focus movement, for example. Specifically, after the display control system is switched from a scroll operation to a focus movement operation, the display control system changes angular displacement necessary for moving focus once into larger angular displacement than usual, thereby lessening focus movement. Accordingly, the display control system can cancel a positional gap caused by a scroll operation using a natural operation of a user who tries to perform positioning.

It is also possible to make a computer program for causing hardware such as CPU, ROM, and RAM built in an information processing apparatus to execute the same functions as the configurations of the operation terminal 1 and the display apparatus 2, or the operation terminal 10 and the display apparatus 20. There is also provided a recording medium having the computer program recorded thereon.

Additionally, the present technology may also be configured as below.

(1) A display control apparatus including:

a display control unit configured to move a cursor position displayed on a display unit or to scroll a screen displayed on the display unit in accordance with a change amount of an indicated direction of a direction indicator; and

a switching control unit configured to switch the display control unit moving the cursor position and the display control unit scrolling the screen,

wherein, after the switching control unit switches the display control unit scrolling the screen to the display control unit moving the cursor position, the display control unit reduces a movement amount of the cursor position with respect to the change amount.

(2) The display control apparatus according to (1),

wherein, after the display control unit reduces the movement amount of the cursor position, the display control unit releases reduction of the movement amount.

(3) The display control apparatus according to (2),

wherein the display control unit releases the reduction of the movement amount at timing according to a changing speed and a changing time of the indicated direction in scrolling the screen before the switching control unit switches the display control unit scrolling the screen to the display control unit moving the cursor position.

(4) The display control apparatus according to (2) or (3), further including:

an estimation unit configured to estimate the indicated direction in accordance with the change amount,

wherein the display control unit releases the reduction of the movement amount when the indicated direction estimated by the estimation unit overlaps with the cursor position.

(5) The display control apparatus according to any one of (2) to (4),

wherein the display control unit releases the reduction of the movement amount on the basis of a changing speed of the indicated direction after the switching control unit switches the display control unit scrolling the screen to the display control unit moving the cursor position.

(6) The display control apparatus according to any one of (2) to (5),

wherein the display control unit releases the reduction of the movement amount on the basis of a changing direction of the indicated direction after the switching control unit switches the display control unit scrolling the screen to the display control unit moving the cursor position.

(7) The display control apparatus according to any one of (1) to (6),

wherein the display control unit fixes the cursor position as reduction of the movement amount.

(8) The display control apparatus according to any one of (1) to (7),

wherein the display control unit keeps the cursor position fixed while scrolling the screen.

(9) The display control apparatus according to any one of (1) to (9), further including:

a reception unit configured to receive information indicating the change amount from the direction indicator.

(10) A display control method including:

moving a cursor position displayed on a display unit or scrolling a screen displayed on the display unit in accordance with a change amount of an indicated direction of a direction indicator;

switching moving the cursor position and scrolling the screen; and

reducing a movement amount of the cursor position with respect to the change amount after scrolling the screen is switched to moving the cursor position.

(11) A program for causing a computer to execute:

moving a cursor position displayed on a display unit or scrolling a screen displayed on the display unit in accordance with a change amount of an indicated direction of a direction indicator;

switching moving the cursor position and scrolling the screen; and

reducing a movement amount of the cursor position with respect to the change amount after scrolling the screen is switched to moving the cursor position.

(12) A display control signal generating apparatus including:

a detection unit configured to detect a change amount of an indicated direction;

a generation unit configured to generate a display control signal that requests a cursor position displayed on a display unit to be moved or a display control signal that requests a screen displayed on the display unit to be scrolled in accordance with the change amount detected by the detection unit; and

a switching control unit configured to switch the generation unit generating the display control signal that requests the cursor position to be moved and the generation unit generating the display control signal that requests the screen to be scrolled,

wherein, after the switching control unit switches the generation unit generating the display control signal that requests the screen to be scrolled to the generation unit generating the display control signal that requests the cursor position to be moved, the generation unit generates a display control signal in which a movement amount of the cursor position with respect to the change amount is reduced.

(13) A display control signal generating method including:

detecting a change amount of an indicated direction;

generating a display control signal that requests a cursor position displayed on a display unit to be moved or a display control signal that requests a screen displayed on the display unit to be scrolled in accordance with the detected change amount;

switching generating the display control signal that requests the cursor position to be moved and generating the display control signal that requests the screen to be scrolled; and

generating a display control signal in which a movement amount of the cursor position with respect to the change amount is reduced after generating the display control signal that requests the screen to be scrolled is switched to generating the display control signal that requests the cursor position to be moved.

(14) A program for causing a computer to execute:

detecting a change amount of an indicated direction;

generating a display control signal that requests a cursor position displayed on a display unit to be moved or a display control signal that requests a screen displayed on the display unit to be scrolled in accordance with the detected change amount;

switching generating the display control signal that requests the cursor position to be moved and generating the display control signal that requests the screen to be scrolled; and

generating a display control signal in which a movement amount of the cursor position with respect to the change amount is reduced after generating the display control signal that requests the screen to be scrolled is switched to generating the display control signal that requests the cursor position to be moved.

(15) A display control system including:

a detection unit configured to detect a change amount of an indicated direction;

a display control unit configured to move a cursor position displayed on a display unit or to scroll a screen displayed on the display unit in accordance with the change amount detected by the detection unit; and

a switching control unit configured to switch the display control unit moving the cursor position and the display control unit scrolling the screen,

wherein, after the switching control unit switches the display control unit scrolling the screen to the display control unit moving the cursor position, the display control unit reduces a movement amount of the cursor position with respect to the change amount.

What is claimed is:

1. A display control apparatus comprising:
a display control unit configured to move a cursor position displayed on a display unit or to scroll a screen displayed on the display unit in accordance with a change amount of an indicated direction of a direction indicator; and
a switching control unit configured to switch the display control unit moving the cursor position and the display control unit scrolling the screen,
wherein, after the switching control unit switches the display control unit scrolling the screen to the display control unit moving the cursor position, the display control unit control unit reduces a movement amount of the cursor position with respect to the change amount.

2. The display control apparatus according to claim 1,
wherein, after the display control unit reduces the movement amount of the cursor position, the display control unit releases reduction of the movement amount.

3. The display control apparatus according to claim 2,
wherein the display control unit releases the reduction of the movement amount at timing according to a changing speed and a changing time of the indicated direction in scrolling the screen before the switching control unit switches the display control unit scrolling the screen to the display control unit moving the cursor position.

4. The display control apparatus according to claim 2, further comprising:
an estimation unit configured to estimate the indicated direction in accordance with the change amount,
wherein the display control unit releases the reduction of the movement amount when the indicated direction estimated by the estimation unit overlaps with the cursor position.

5. The display control apparatus according to claim 2,
wherein the display control unit releases the reduction of the movement amount on the basis of a changing speed of the indicated direction after the switching control unit switches the display control unit scrolling the screen to the display control unit moving the cursor position.

6. The display control apparatus according to claim 2,
wherein the display control unit releases the reduction of the movement amount on the basis of a changing direction of the indicated direction after the switching control unit switches the display control unit scrolling the screen to the display control unit moving the cursor position.

7. The display control apparatus according to claim 1,
wherein the display control unit fixes the cursor position as reduction of the movement amount.

8. The display control apparatus according to claim 1,
wherein the display control unit keeps the cursor position fixed while scrolling the screen.

9. The display control apparatus according to claim 1, further comprising:
a reception unit configured to receive information indicating the change amount from the direction indicator.

10. A display control method comprising:
moving a cursor position displayed on a display unit or scrolling a screen displayed on the display unit in accordance with a change amount of an indicated direction of a direction indicator;
switching moving the cursor position and scrolling the screen; and
reducing a movement amount of the cursor position with respect to the change amount after scrolling the screen is switched to moving the cursor position.

11. A program for causing a computer to execute:
moving a cursor position displayed on a display unit or scrolling a screen displayed on the display unit in accordance with a change amount of an indicated direction of a direction indicator;
switching moving the cursor position and scrolling the screen; and
reducing a movement amount of the cursor position with respect to the change amount after scrolling the screen is switched to moving the cursor position.

12. A display control signal generating apparatus comprising:
a detection unit configured to detect a change amount of an indicated direction;
a generation unit configured to generate a display control signal that requests a cursor position displayed on a display unit to be moved or a display control signal that requests a screen displayed on the display unit to be scrolled in accordance with the change amount detected by the detection unit; and
a switching control unit configured to switch the generation unit generating the display control signal that requests the cursor position to be moved and the generation unit generating the display control signal that requests the screen to be scrolled,
wherein, after the switching control unit switches the generation unit generating the display control signal that requests the screen to be scrolled to the generation unit generating the display control signal that requests the cursor position to be moved, the generation unit generates a display control signal in which a movement amount of the cursor position with respect to the change amount is reduced.

13. A display control signal generating method comprising:
detecting a change amount of an indicated direction;
generating a display control signal that requests a cursor position displayed on a display unit to be moved or a display control signal that requests a screen displayed on the display unit to be scrolled in accordance with the detected change amount;
switching generating the display control signal that requests the cursor position to be moved and generating the display control signal that requests the screen to be scrolled; and
generating a display control signal in which a movement amount of the cursor position with respect to the change amount is reduced after generating the display control signal that requests the screen to be scrolled is switched to generating the display control signal that requests the cursor position to be moved.

14. A program for causing a computer to execute:
detecting a change amount of an indicated direction;
generating a display control signal that requests a cursor position displayed on a display unit to be moved or a display control signal that requests a screen displayed on the display unit to be scrolled in accordance with the detected change amount;
switching generating the display control signal that requests the cursor position to be moved and generating the display control signal that requests the screen to be scrolled; and
generating a display control signal in which a movement amount of the cursor position with respect to the change amount is reduced after generating the display control signal that requests the screen to be scrolled is switched to generating the display control signal that requests the cursor position to be moved.

15. A display control system comprising:
a detection unit configured to detect a change amount of an indicated direction;
a display control unit configured to move a cursor position displayed on a display unit or to scroll a screen displayed on the display unit in accordance with the change amount detected by the detection unit; and
a switching control unit configured to switch the display control unit moving the cursor position and the display control unit scrolling the screen,
wherein, after the switching control unit switches the display control unit scrolling the screen to the display control unit moving the cursor position, the display control unit reduces a movement amount of the cursor position with respect to the change amount.
